(19) United States
(12) Patent Application Publication
(10) Pub. No.: US 2010/0090974 A1
(43) Pub. Date: Apr. 15, 2010

(54) Switch and portable terminal using the same

(75) Inventors: Jin-He Jung, Suwon-si (KR); Suk-Soon Kim, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/587,822

(22) Filed: Oct. 14, 2009

(30) Foreign Application Priority Data
Oct. 14, 2008 (KR) 10-2008-0100694

(51) Int. Cl. G06F 3/041

(52) U.S. Cl. 345/173

(57) ABSTRACT

A system and method for providing an input to a portable terminal includes a switch for a portable terminal with a touch screen. The switch includes a suction plate attachable onto the main screen; and a button inserted into the suction plate, the button touching the touch screen when it is pushed.

### CROSS-REFERENCE TO RELATED APPLICATION(S) AND CLAIM OF PRIORITY

This application claims the priority under 35 U.S.C. §119(a) of an application entitled “Switch And Portable Terminal Using The Same” filed in the Korean Industrial Property Office on Oct. 14, 2008 and assigned Ser. No. 10-2008-0100694, the contents of which are hereby incorporated by reference.

### TECHNICAL FIELD OF THE INVENTION

The present invention relates to an input device, and more particularly, to an input device for a portable digital device.

### BACKGROUND OF THE INVENTION

Recently, mobile games have been extensively developed to such an extent that several hundred thousand polygons are supported. In addition, portable terminals, each of which has a wide touch screen, a high capacity memory, and a CPU with an advanced operation-processing capacity, have been popularized.

Due to the above-mentioned technical environments, it is possible to enjoy diverse genres of high-specification games even by using a portable terminal. Due to the limited size of such a portable terminal, however, input means are limited contrary to diversified game genres and enjoyable game genres are also limited. Games that are enjoyable on a portable terminal are limited to ordinary game genres that allow one or two types of input by using a sensor.

In addition, the existing game platforms do not catch up with the change of portable terminals as described above. Intuitive analogue precision is required for a game input device. However, it is not easy to use a touch screen as a game platform.

Portable terminals include a plurality of buttons and direction keys that are used as input means.

As an example of portable terminals, .i-Phones are provided with a plurality of games developed as a demo game form by individual developers or third party entities. However, the games are typically limited to simple game genres using a touch screen and sensors without using keys.

In order to support more diverse game genres, there have been proposed a method for providing software keys on a touch screen (U.S. Patent Publication No. 2007/0021210A1), an input device capable of being coupled to a portable terminal in the form of a gun provided with a plurality of sensors, and a portable terminal with an electric compass.

In addition, there has been proposed an X-Box® controller or an input device usable in combination with a portable terminal as disclosed in the U.S. Patent Publication No. 2007/0021210A1.

However, the keys implemented on a touch screen in a software form have a problem in that they lack a touch feeling which allows a user to confirm whether a selection has been made or not. As a result, the user may lose the position of the keys while enjoying a game, or may not recognize the feeling provided when the keys are pushed.

Furthermore, there is a problem in that manipulating games only with a direction key is limited, and the number of keys used for various genres of games is also limited.

Since the game platforms applicable to a portable terminal with a touch screen are limited, the game genres applicable to a portable terminal are also limited to the genres capable of being implemented with an input device having few buttons. In addition, since the existing means proposed for solving the above-mentioned problems are limited to analogue input devices or software means, no proposal concerning user's click feeling was made or a single input device was not applicable to various genres of games.

### SUMMARY OF THE INVENTION

To address the above-discussed deficiencies of the prior art, it is a primary object to solve the above-mentioned problems occurring in the prior art, and the present invention provides an input device which can support various genres of games on a portable terminal having a touch screen.

According to an aspect of the present invention, there is provided a switch attachable onto a touch screen including: a dome-shaped suction plate attached to a touch screen, and a button inserted into the suction plate, the button touching the touch screen when it is pushed.

According to another aspect of the present invention, there is provided an input device for a portable terminal with a touch screen including: a suction plate attachable onto the main screen; and at least one button inserted into the suction plate, the button touching the touch screen when it is pushed by a user, the button being spaced from the touch screen so that it gets in touch with the touch screen when it is pushed by a user.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate cross-sectional views for describing a switch in accordance with an embodiment of the present invention and its operation;

FIGS. 2A and 2B illustrate cross-sectional views for describing a switch in accordance with another embodiment of the present invention and its operation;

FIG. 3A illustrates a schematic block diagram of an example of a configuration of an input device for a portable terminal in accordance with another embodiment of the present invention;

FIG. 3B illustrates a schematic view of a configuration of a game platform to be capable of being provided through a portable terminal; and

FIG. 4 illustrates a view for describing an operation of a portable terminal in accordance with another embodiment of the present invention.

### DETAILED DESCRIPTION OF THE INVENTION

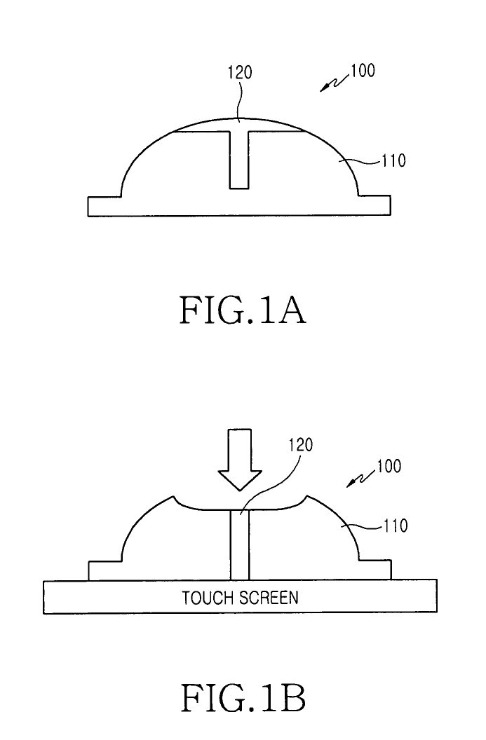

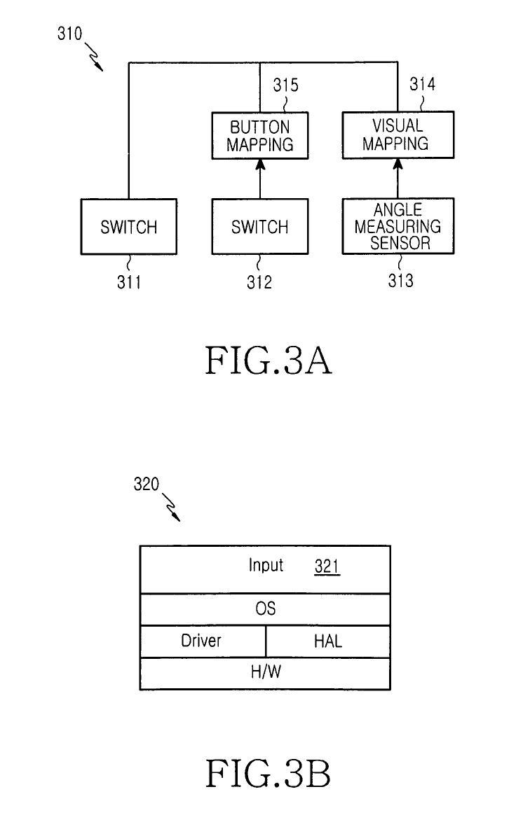

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged input device.

Hereinafter, exemplary embodiments of the present invention will be described with reference to the accompanying drawings. In the following description, a detailed description of known functions and configurations incorporated herein will be omitted when it may make the subject matter of the present invention rather unclear.

FIGS. 1A and 1B illustrate cross-sectional views for describing a switch in accordance with an embodiment of the present invention and its operation. Referring to FIGS. 1A and 1B, the switch 100 for a portable terminal with a touch screen includes a dome-shaped suction plate 110 attached to the touch screen 100, and a button 120 inserted into the suction plate 110 and touching the touch screen when it is pushed.

At least one switch 100, in accordance with an aspect of the present invention, may be provided as an input device for a portable terminal, wherein the switch 100 may be attached to or detached from the touch screen of the portable terminal. Therefore, the switch may be used as an input device for a portable terminal with a touch screen, which can provide a click feeling to a user together with a switch provided in a software form through the touch screen.

In some embodiments, the suction plate 110 may be formed in a dome shape from a material, such as a highly elastic rubber or silicon, and a rod-shaped button 120 is inserted into the center of the suction plate 110.

When the user pushes the button 120, the suction plate 110 is deformed and, as a result, the button 120 touches the touch screen of the portable terminal. Consequently, by one input means, which touches the switch, among the input means provided through the touch screen in the form of software, the user's intended selection can be implemented.

In some embodiments where the touch screen is an electrostatic capacity type, the button 120 may be formed from a conductive material. In embodiments where the touch screen is a resistive type, any material may be employed for the button 120 regardless of whether the material is conductive or not, i.e., the material is a conductor or an insulator.

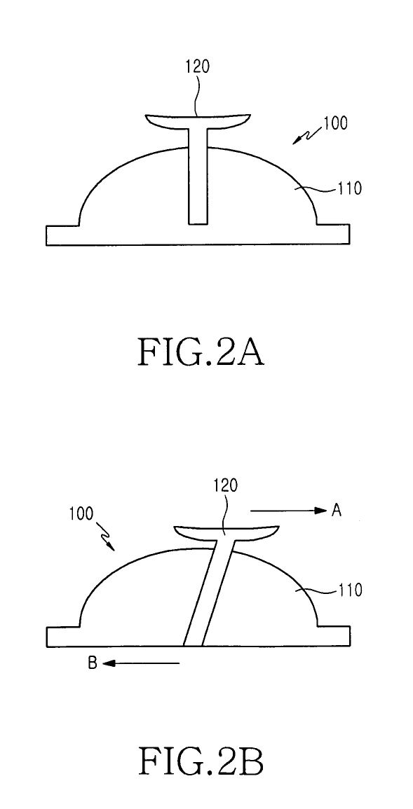

FIGS. 2A and 2B illustrates a switch for enjoying a game of a portable terminal according to another embodiment of the present invention. The present embodiment is the same as the embodiment described in that if a user pushes the button, the suction plate is deformed so that information is input through the touch screen. However, as shown in FIGS. 2A and 2B, the switch of the present embodiment takes a form of a stick that can be used as a navigation key for inputting direction.

In embodiments where the button 120 is used as a navigation key, the point on the touch screen to be touched by the button 120 may be positioned in direction B opposite to direction A selected by the user. Therefore, a program, such as a button mapper, may be employed so that the direction selected by the user is converted by the program by mapping in accordance with the touch of the button.

A portable terminal according to another embodiment of the present invention may include a game platform 320 implemented by software on the touch screen of the portable terminal, and an input device 310 for supporting a user in such a manner that information items selected by the user are input through the game platform 320. The input device 310 also provides the user with a click feeling.

The input device 310 may include a plurality of switches 311 and 312, a button mapper 315, an angle measuring sensor 313, and a visual point mapper 314.

Switches as shown in FIGS. 1A and 2A can be used as the switches 311 and 312. One of the switches 311 and 312 may be implemented as a navigation key by employing a stick-shaped switch that enables inputting direction as a navigation key as shown in FIG. 2A, and the button mapper 315 may be used so as to allow the direction selected by the user to be correctly input.

The switch 212 used for inputting direction as a navigation key may touch the touch screen at a point in the direction opposite to that indicated by the user as shown in FIG. 2b. Therefore, a program for the button mapper 315 may be used which allows the point touched by the button on the touch screen to be recognized without errors, even though the touched point is positioned opposite to the direction intended by the user. The button mapper 315 is capable of removing reverse directionality which renders the direction intended by the user to be oppositely input through the touch screen, and capable of providing four or more direction angles.

If the pressure exerted by the user is removed from the inventive switch 311 or 312 by removing the user's finger from the pushed button, the suction plate is returned to the original shape it took before it is pushed by the user. If the suction plate is returned to its original shape, the button is also spaced from the touch screen by a predetermined distance.

The angle measuring sensor 313 is a sensor for detecting the rotated direction of the portable terminal. The angle measuring sensor 313 can measure an angle changed from the initial position of the portable terminal when the user rotates the portable terminal so as to implement a character's visual point on the game. In addition, the visual point mapper 314 analyzes the rotated angle so as to transmit the rotated angle obtained from the angle measuring sensor 315 to the character on the game, and produces information for changing the visual point with the sensitivity suitable for the game character. In addition, the visual point mapper 314 may store the rotated angle at the time of initiating the game, and provide the angle as reference in relation to a value obtained by the sensor during the game.

The portable terminal provides the game platform 320 in a software form through the touch screen, and the game platform 320 may be provided for the user, together with the inventive switches 311 and 312, as an input device for the portable terminal. That is, the output of the switches 311 and 312, the button and visual point mappers 314 and 315 may be input through the game input part 321 of the game platform 320 which has been implemented by software.

The game platform 320 may consist of the game input part 321 for transmitting information input to the game program through the input device 310, an Operating System (OS), a driver, HAL, H/W, and the like.

Required input items for games are diverse depending on the game genre, the game supplier, and the games' own characteristics. The inventive working characters in connection with the required input items for individual game genres may be classified into three game genres as follows.

An arcade-type game is an ordinary type game genre, which requires one navigation key and two to four switches. That is, if a user drives the game, it is possible to execute a game of the corresponding genre by attaching the inventive switches on the touch screen corresponding to the input means of a software provided for the game.

A racing genre game, such as Kart Rider and Need for Speed, is a game genre for which handling is important. For smooth handling, an angle measuring sensor and a mapper are used.

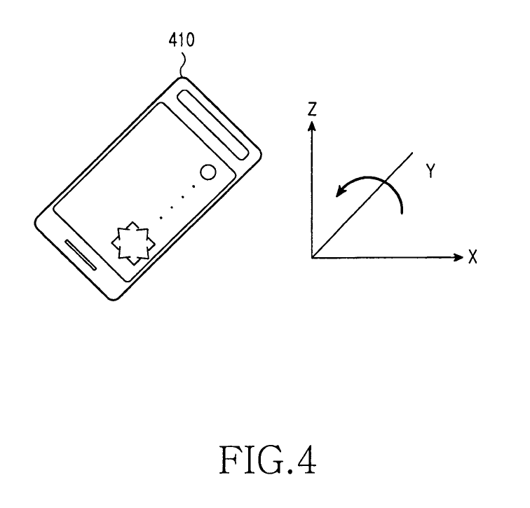

FIG. 4 illustrates a view for explaining how a portable terminal with the inventive input device and a game platform maps a change of visual point to a character in a game through handling.

If a user rotates the portable terminal 410 left about the Y-axis, the steering wheel of the car in the game is also rotated left. However, the game picture should not be rotated when the portable terminal 410 is rotated.

An FPS genre game requires a number of types of user's input. For this game, a direction switch for moving a character, a switch for arranging the visual point of the character, and switches for moving a plurality of items.

For an FPS genre game, a stick-type switch and a button-type switch can be concurrently used. The stick-type switch is a switch as shown in FIG. 2A, which means a switch usable for indicating a direction, and the button-type switch is a switch as shown in FIG. 1A, which means a switch for inputting ordinary information or information selected by the user.

The present invention allows a user of a portable terminal with a touch screen to enjoy all genres of games on the user's portable terminal, that can be implemented only on a conventional terminal, by providing an analogue type input device and software for supporting the input device for the portable terminal with the touch screen.

That is, the present invention can provide diverse input means, through which a user can experience a click feeling, by providing switches having a physical feature for allowing attachment and detachment to input means implemented by software on a touch screen. Therefore, according the present invention, various genres of games can be implemented through a portable terminal with input means implemented by software on the touch screen thereof.

While the invention has been shown and described with reference to certain exemplary embodiments thereof, it will be understood by those skilled in the art that various changes in form and details may be made therein without departing from the spirit and scope of the invention as defined by the appended claims.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A switch for a portable terminal with a touch screen, the switch comprising:
a suction plate attachable onto the main screen; and
a button inserted into the suction plate, the button configured to touch the touch screen when the button is pushed.

2. The switch according to claim 1, wherein the suction plate comprises a dome shape

3. The switch according to claim 2, wherein the suction plate configured to be deformed by pressure.

4. The switch according to claim 3, wherein the suction plate is configured to be returned to its original dome shape when the pressure is removed.

5. The switch according to claim 1, wherein the button is rod-shaped and inserted at a position that is substatially at a center position of the suction plate.

6. The switch according to claim 1, wherein the button comprises a conductive material.

7. The switch according to claim 1, wherein the button is configured to contact the touch screen in a first direction opposite from a second direction selected by a user.

8. An input device for a portable terminal with a touch screen, comprising:
a suction plate attachable onto the main screen; and
at least one button inserted into the suction plate, the button touching the touch screen when it is pushed by a user, the button being spaced from the touch screen such that the button physically contacts the touch screen when the button is pushed by a user.

9. The input device according to claim 8, wherein the suction plate comprises a dome shape.

10. The input device according to claim 9, wherein the button gets in touch with the touch screen when the user pushes and deforms the suction plate.

11. The input device according to claim 8, wherein the button is formed from a conductive material.

12. The input device according to claim 8, further comprising:
an angle measuring sensor configured to measure a rotated angle of the portable terminal; and
a visual point mapper configured to convert the rotated angle of the portable terminal measured by the angle measuring sensor to a visual point of a character in the game or to a visual point of the user.

13. The input device according to claim 8, wherein the button is rod-shaped and inserted at a position that is substatially at a center position of the suction plate.

14. The input device according to claim 8, wherein the button is configured to contact the touch screen in a first direction opposite from a second direction selected by a user.

15. A method for receiving an input for a portable terminal with a touch screen, the method comprising:
receiving, by a button inserted into a suction plate, an input from a user, wherein the input comprises a push of the button and the suction plate is attachable onto the main screen;
contacting, via the suction plate, the touch screen when the button is pushed.

16. The method according to claim 15, wherein the suction plate comprises a dome shape configured to be deformed by pressure.

17. The method according to claim 16, wherein the suction plate is configured to be returned to its original dome shape when the pressure is removed.

18. The method according to claim 15, wherein the button is rod-shaped and inserted in the center of the suction plate.

19. The method according to claim 15, further comprising:
measuring a rotated angle of the portable terminal; and
converting the rotated angle of the portable terminal to a visual point of a character in the game or to a visual point of the user.

20. The method according to claim 15, wherein contacting further comprises contacting the touch screen in a first direction opposite from a second direction selected by a user.
